(19) United States
(12) Patent Application Publication
(10) Pub. No.: US 2018/0157695 A1
(43) Pub. Date: Jun. 7, 2018

(54) MASTER ENQUEUE SERVICE FOR HANDLING OBJECT LOCKS

(71) Applicant: SAP SE, Walldorf (DE)

(72) Inventors: ZAWISZA PIERZCHALSKI, Heidelberg (DE); Mariusz Debowski, Sandhausen (DE)

(21) Appl. No.: 15/371,078

(22) Filed: Dec. 6, 2016

(51) Int. Cl. G06F 17/30

(52) U.S. Cl. CPC G06F 17/30362; G06F 17/30371

(57) ABSTRACT

A master enqueue service can be implemented to manage locks on objects that may be requested by one or more requesting applications in communication with one or more local enqueue services. A master enqueue service can receive a query from a local enqueue service regarding a lock status of an object upon the local enqueue service having received a request from a requesting application to lock the object and having determined that the local enqueue service does not currently have the object locked. The master enqueue service can reply to the local enqueue service with a confirmation when none of the one or more enqueue services managed by the master enqueue service has the object locked, thereby indicating that the local enqueue service can implement a lock on the object for the requesting application. In the event that another of the enqueue services managed by the master enqueue service has the object locked, the master enqueue service can reply to the requesting application with a denial.

### TECHNICAL FIELD

The subject matter described herein relates to a master enqueue service for handling object locks in a multi-application environment.

### BACKGROUND

In a computing environment in which multiple applications can require access to data objects (e.g. tables, columns, or the like maintained by a database management system), a lock system can be necessary to avoid collisions in which one application attempts to modify or otherwise write to an object concurrently with another application. One approach to this issue involves the use of an enqueue service.

### SUMMARY

In one aspect, a method includes receiving a request from a requesting application to lock an object at a first enqueue service, determining that the first enqueue service does not currently have the object locked, querying a master enqueue service regarding a lock status of the object; and implementing a lock on the object (by the first enqueue service) for the requesting application upon receiving confirmation from the master enqueue service that no other enqueue service of one or more other enqueue services managed by the master enqueue service has the object locked.

In another interrelated aspect, a method includes receiving, at a master enqueue service, a query from a local enqueue service regarding a lock status of an object. The local enqueue service has received a request from a requesting application to lock the object and to determine that the local enqueue service does not currently have the object locked. The method also includes use of the master enqueue service for determining whether any of one or more other enqueue services managed by the master enqueue service already has the object locked, and replying to the local enqueue service with a confirmation when none of the one or more other enqueue services managed by the master enqueue service has the object locked, to indicate that the local enqueue service can implement a lock on the object for the requesting application.

In some variations one or more of the following features can optionally be included in any feasible combination. The method can further include sending an acknowledgement to the requesting application. The master enqueue service can be one of the one or more other enqueue services. The lock cannot be implemented if the master enqueue service does not provide confirmation that no other enqueue service has the object locked and/or if the master enqueue service replies with a denial, thereby indicating that another enqueue service managed by the master enqueue service has the object locked. The one or more other enqueue services can include a plurality of other enqueue services.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory may include, encode, store, or the like one or more programs that cause one or more processors to perform one or more of the operations described herein. The memory can include a non-transitory computer-readable or machine-readable storage medium. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a computer-based server or service for handling access by multiple applications to objects in a database, it should be readily understood that such features are not necessarily intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter;

FIG. 2 shows a diagram illustrating operations of a process flow for handling of object locks via a single enqueue service;

FIG. 3 shows a diagram illustrating operations of a process flow for handling of object locks via an approach including a master enqueue service consistent with implementations of the current subject matter;

FIG. 4 shows a process flow diagram illustrating aspects of a method having one or more features consistent with implementations of the current subject matter; and

FIG. 5 shows a process flow diagram illustrating aspects of another method having one or more features consistent with implementations of the current subject matter.

When practical, similar reference numbers denote similar structures, features, or elements.

### DETAILED DESCRIPTION

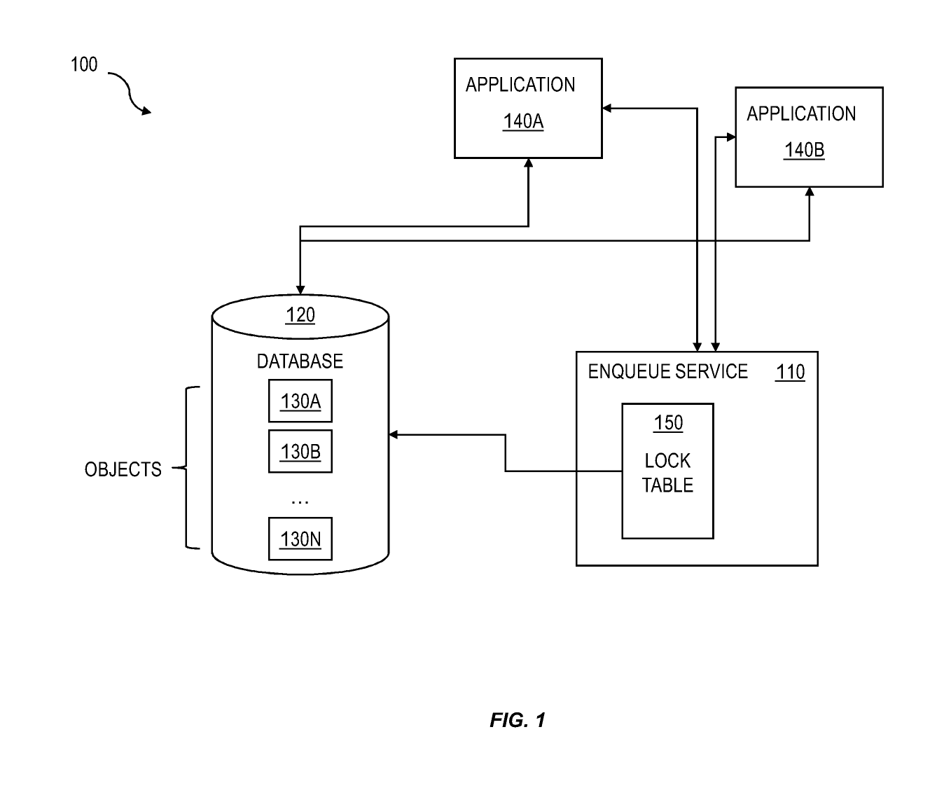

An enqueue service generally functions as a locking mechanism or service, which can be implemented via one or more servers or other computing machines, for managing locks on one or more objects usable by applications, which can execute on one or more processors. For example, as illustrated in the computing landscape diagram 100 of FIG. 1, an enqueue service 110 can be implemented for a database 120 or other object store that includes multiple objects 130A, 130B, . . . 130N. The enqueue service manages access to these database objects 130A, 130B, . . . 130N by multiple applications 140A, 140B (it will be understood that FIG. 1 shows two applications but that any number of applications whose access to database objects is managed by an enqueue server 110 is consistent with the current disclosure) that may temporarily require exclusive access to a given object. An enqueue service 110 can also be referred to as a lock server and/or an enqueue server. One example of operation of an enqueue service includes the enqueue server maintaining a lock table 150 in which the enqueue service adds an entry for a given object when that object is locked for exclusive use by an application 140A, 140B, etc.

The applications 140A, 140B, etc. can execute on common processors with the database 120 and/or the enqueue service 110, or each of these processes can be on separate computing hardware, or any combination. In some examples, an enqueue service can be configured as an enqueue work process in a central instance of the database or other object store. In other approaches, an enqueue server can be installed as part of a separate instance, for example in a standalone enqueue service implementation.

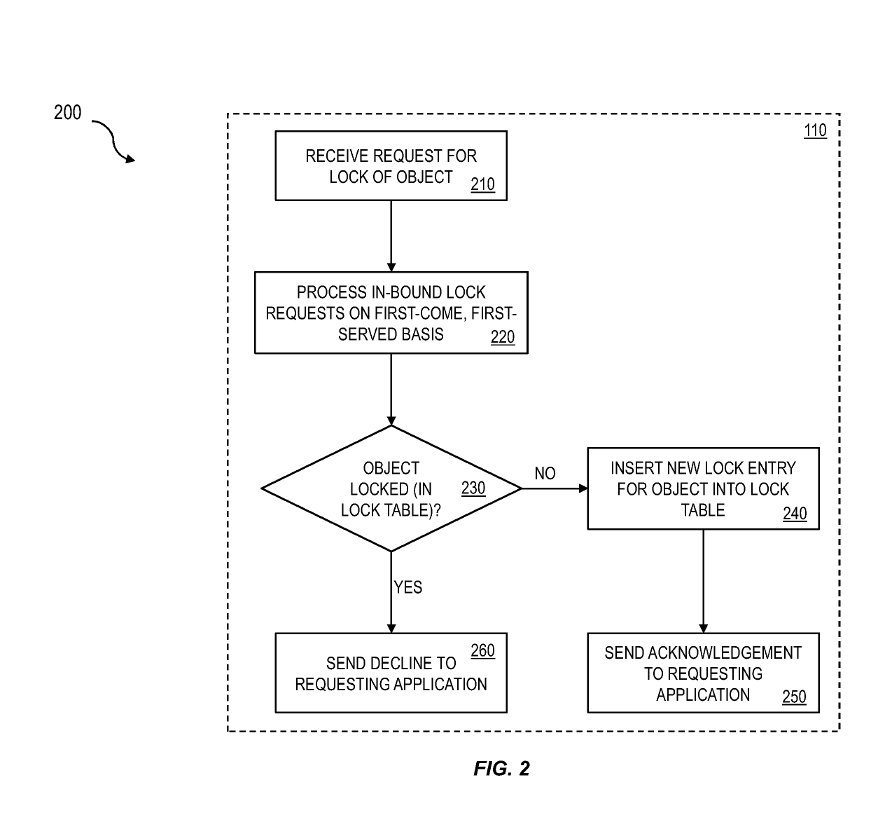

FIG. 2 shows a process diagram 200 illustrating an existing approach to implementing an enqueue service. All operations in FIG. 2 can be performed by a single instance of an enqueue service, which can be implemented on one or more computers (e.g. servers, etc.). At 210, the enqueue service receives a request for a lock of an object (also referred to as an application object) from an application. The enqueue service processes such in-bound lock requests on a first-come, first-serve basis at 220. At 230, the enqueue service determines whether the object is already locked (e.g. whether a lock table managed or maintained by the enqueue service has an entry for the object). If the object is not locked, at 240 the enqueue service implements a lock on the object for the application (e.g. the enqueue service inserts a new lock entry for the object into the lock table). The enqueue service also sends an acknowledgement to the application indicating that the object is locked for that application. If the enqueue service determines at 230 that the object is already locked (e.g. by a different application), the enqueue service sends a decline message to the application at 260 to indicate that the application cannot have a lock on the object. At 250, the enqueue service also sends an acknowledgment to the requesting application that the object is locked for that application.

As illustrated in FIG. 1 and FIG. 2 and described above, the enqueue service 110 manages the lock table 150 to keep track of existing locks on objects and to handle locking and releasing of objects. The enqueue service 110 can receive a lock request and check the lock table 150 to determine whether the lock request collides with an existing lock. If it does, the enqueue service rejects it. If it does not collide, the enqueue service 110 sets the lock and makes the entry in the lock table 150. The enqueue service can therefore hold critical data in the lock table 150 in the main memory: all locks that are currently held by users. If the host on which the enqueue service is implemented fails, these data are lost and cannot be restored even when the enqueue service 110 is restarted. All transactions that have been held in a locked state by the enqueue service would therefore need to be reset upon a failure or other shutdown of the enqueue service. For this reason, provision of system redundancy for the enqueue service can be desirable. Currently available solutions generally do not readily support non-disruptive enqueue service replacement. In other words, because the enqueue service 110 is generally managed as a unified instance, system reliability is generally supplied by use of a redundant enqueue server that replicates the data on the main instance of the enqueue service. However, such an approach generally does not satisfactorily support an update of the enqueue service without disruption.

Implementations of the current subject matter can provide this desirable feature, among other possible benefits. For example, unlike previously available approaches, a master enqueue service consistent with implementations of the current subject matter does not require a shut down of the enqueue service in case of a software update or hardware replacement (which would cause any application using locks supported by the enqueue service to stop working). Other reasons that can require replacement of an enqueue service can include error correction within the enqueue service or because of the compatibility of the enqueue server with connected system components. In some further variations, the current approach can be implemented to cover the availability of the enqueue service in a comprehensive manner.

Various implementations of the current subject matter can address various shortcomings of currently available solutions through the use of a master enqueue service or server. A master enqueue service as described herein can make it possible to replace an enqueue service without disruption.

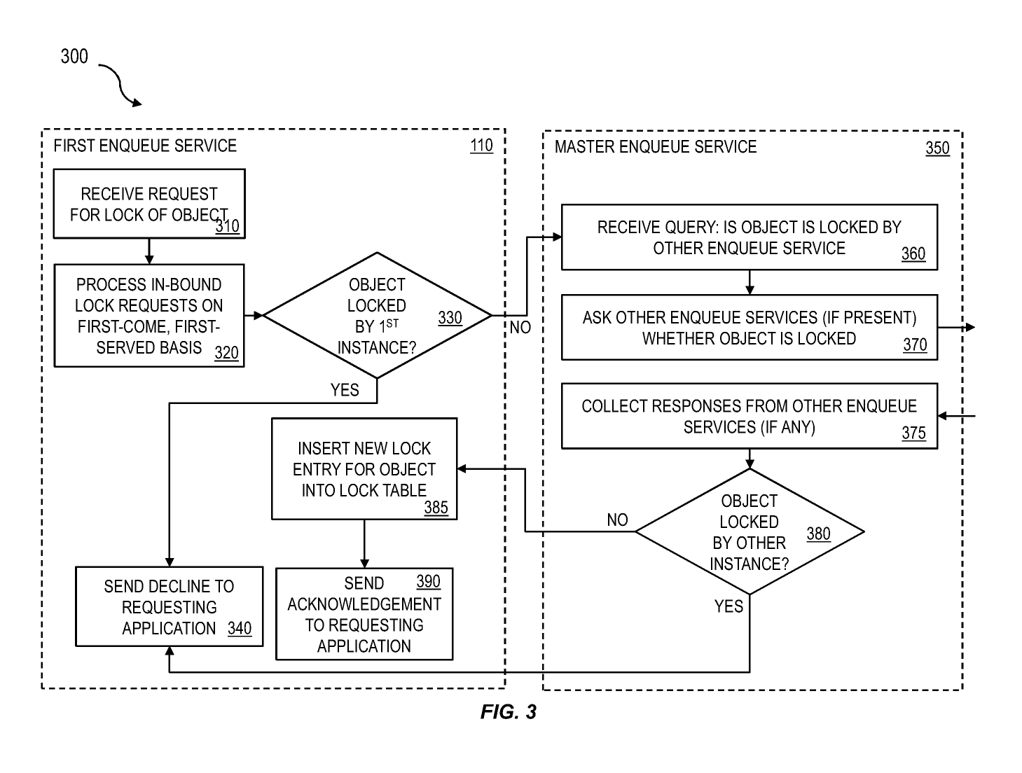

FIG. 3 shows a process diagram 300 illustrating an approach to implementing enqueue services with inclusion of a master enqueue service for mediating between multiple concurrent enqueue service instances. For simplicity, the FIG. 3 shows operations for a first enqueue service 110, which receives a request for an object lock from a requesting application at 310. As in the example of FIG. 2, the first enqueue service 110 processes such in-bound lock requests on a first-come, first-serve basis at 320 and determines, at 330, whether it (i.e. the first enqueue service) has a local lock on the object. If so, the operations proceed again as in FIG. 2: the requesting application is sent a “decline” for the lock request at 340.

Unlike in FIG. 2, if the first enqueue service 110 determines at 330 that it does not have a local lock on the object, the first enqueue service 110 queries (at 360) a master enqueue service 350, which contains information about all managed enqueue services, for information regarding whether any other enqueue service managed by the master enqueue service 350 has a lock on the object. If the master enqueue service 350 is the only other enqueue service besides the first enqueue service 110, the master enqueue service 350 can simply check its own lock table (and/or whatever other mechanism it uses to track locks on objects). However, in an example in which the master enqueue service 350 manages multiple other enqueue services (e.g. in addition to the first enqueue service 110), at 370 the master enqueue service 350 can ask the other enqueue services if any of them have a lock on the object and receive replies at 375. Based on knowledge of any local locks at the master enqueue service 350 itself and replies from all other enqueue services managed by the master enqueue service 350, the master enqueue service 350 determines at 380 whether any locks exist on the lock across the managed enqueue services. If yes, the master enqueue service 350 notifies the first enqueue service 110 and the decline reply 340 is sent to the requesting application. If no, the master enqueue service 350 notifies the first enqueue service 110, which inserts a new lock entry for the object into its lock table at 385 and sends an acknowledgement of the lock to the requesting application at 390.

As noted above, implementations of the current subject matter can be useful in supporting a swap out of an enqueue service. For example, in a planned enqueue service replacement, an existing enqueue service 110 can be connected to the master enqueue service 350 as a slave and can then confirm all lock requests received form requesting applications with the master enqueue service 350. Thereafter, a new (e.g. a replacement) enqueue service can be initiated and also connected as a slave to the master enqueue service 350. The new enqueue service can be created as a target solution, in other words as an upgraded version of the original enqueue server. Once the new enqueue service is fully functional, the application lock requests can be directed to this new service instead of to the original enqueue service. Any remaining lock entries on the original enqueue service will be gradually released (according to a standard dequeue mechanism, which can remain unchanged). Once the lock list managed by the original enqueue service no longer contains any active locks, the original enqueue server can be switched off. As a result, master checks via the master enqueue service 350 are no longer necessary and the new enqueue service can be detached from the master enqueue service 350. All applications will continue operations using the new enqueue service, and the master enqueue service 350 can be deactivated.

The procedure described above can be extended to temporarily operate with a larger number of enqueue services, if necessary. Switching on and off of enqueue services would follow the same sequence of steps. The master enqueue service 350 can be deactivated in the end, when only one enqueue service stays active (and master check is therefore no longer needed).

In some situations it can be preferred to upgrade the original enqueue service in place (e.g. due to requirements regarding the file location of its executables). In this case the introduced master enqueue service and new enqueue service can serve continuous lock requests for the time when the original enqueue service is being upgraded.

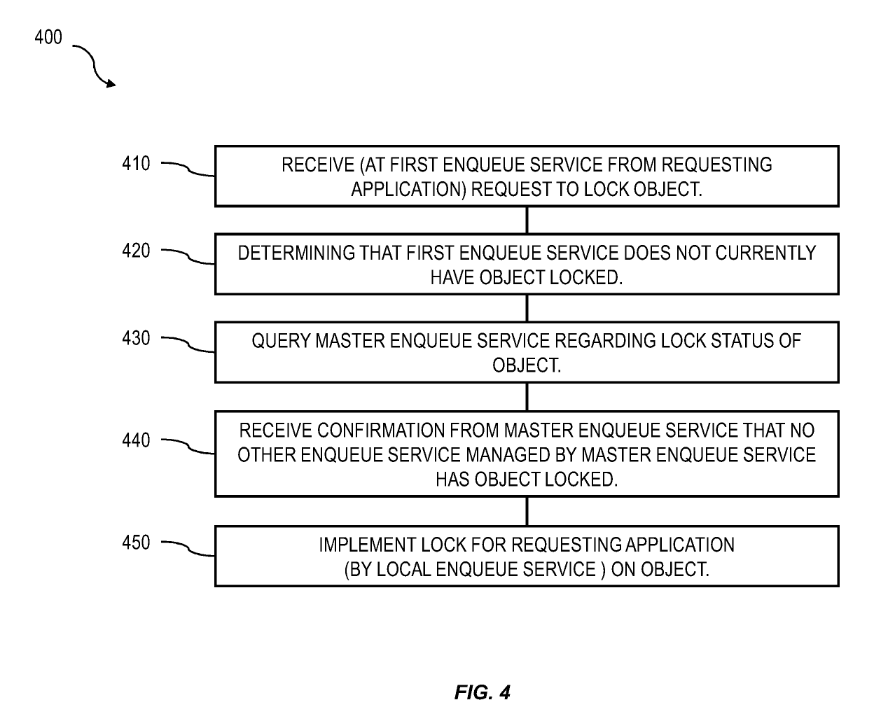

FIG. 4 shows a process flow chart 400 illustrating features of a method that can be included in one or more implementations of the current subject matter. At 410, a first enqueue service receives a request from a requesting application to lock an object in a database managed by the first enqueue server. The first enqueue service determines at 420 that it does not currently have the object locked and if so, at 430 queries a master enqueue service regarding a lock status of the object. At 440, the first enqueue service receives confirmation from the master enqueue service that no other enqueue service managed by the master enqueue service (optionally including the master enqueue service itself) has the object locked. Upon receipt of the confirmation, a lock is implemented on the object for the requesting application at 450, and an acknowledgment of the request can be sent to the requesting application. The one or more other enqueue services can optionally include multiple other enqueue services, optionally including the master enqueue service.

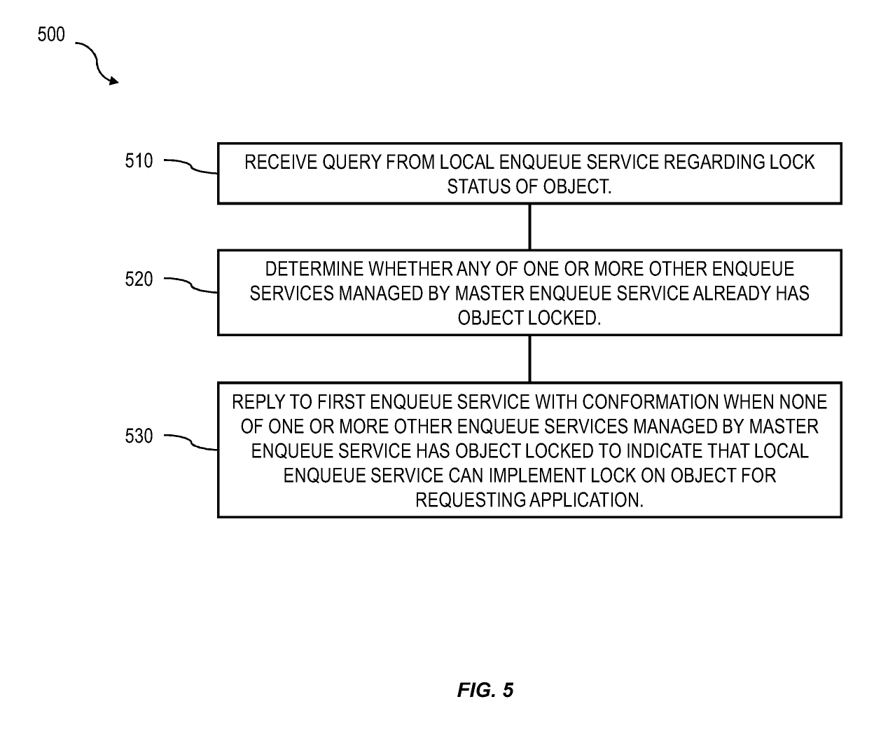

FIG. 5 shows a process flow chart 500 illustrating features of another method that can be included in one or more implementations of the current subject matter. At 510, a master enqueue service receives a query from a first enqueue service regarding a lock status of an object. The first enqueue service has received a request from a requesting application to lock the object and determined that the first enqueue service does not currently have the object locked. At 520, the master enqueue service determines whether any of one or more other enqueue services managed by the master enqueue service already has the object locked, and replies at 530 to the first enqueue service with a confirmation when none of the one or more other enqueue services managed by the master enqueue service has the object locked to indicate that the first enqueue service can implement a lock on the object for the requesting application. The one or more other enqueue services can optionally include multiple other enqueue services, optionally including the master enqueue service.

In a case in which the first enqueue service already has a lock on the object, for example a lock implemented in response to a request for the object from another application, the first enqueue service can decline the lock request from the requesting application. Similarly, if the master enqueue service does not provide confirmation that no lock is implemented on the object by any other enqueue service (or if the master enqueue service affirmatively replies to indicate that the object is locked by action of another enqueue service), the first enqueue service can similarly decline to provide a lock on the object for the requesting application.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
receiving a request to lock an object at a first enqueue service, the request being received from a requesting application;
determining that the local enqueue service does not currently have the object locked;
querying a master enqueue service regarding a lock status of the object; and
implementing a lock on the object for the requesting application upon receiving confirmation from the master enqueue service that no other enqueue service of one or more other enqueue services managed by the master enqueue service has the object locked.

2. A computer program product as in claim 1, wherein the operations further comprise sending an acknowledgement to the requesting application.

3. A computer program product as in claim 1, wherein the master enqueue service is one of the one or more other enqueue services.

4. A computer program product as in claim 1, wherein the lock is not implemented if the master enqueue service does not provide confirmation that no other enqueue service has the object locked.

5. A computer program product as in claim 1, wherein the lock is not implemented if the master enqueue service replies with a denial, thereby indicating that another enqueue service managed by the master enqueue service has the object locked.

6. A computer program product as in claim 1, wherein the one or more other enqueue services comprise a plurality of other enqueue services.

7. A computer program product comprising a non-transitory machine-readable medium storing instructions that, when executed by at least one programmable processor, cause the at least one programmable processor to perform operations comprising:
receiving, at a master enqueue service, a query from a first enqueue service regarding a lock status of an object, the first enqueue service having received a request from a requesting application to lock the object and having determined that the first enqueue service does not currently have the object locked; and
determining, by the master enqueue service, whether any of one or more other enqueue services managed by the master enqueue service already the object locked;
replying to the first enqueue service with a conformation when none of the one or more other enqueue services managed by the master enqueue service has the object locked to indicate that the first enqueue service can implement a lock on the object for the requesting application.

8. A computer program product as in claim 7, wherein the master enqueue service is one of the one or more other enqueue services.

9. A computer program product as in claim 7, wherein the master enqueue service does not reply with the confirmation if any of the one or more other enqueue services has the object locked.

10. A computer program product as in claim 7, wherein the master enqueue service replies with a denial if any of the one or more other enqueue services has the object locked.

11. A system comprising:
computer hardware configured to perform operations comprising:
receiving a request to lock an object at a first enqueue service, the request being received from a requesting application;
determining that the local enqueue service does not currently have the object locked;
querying a master enqueue service regarding a lock status of the object; and
implementing a lock on the object for the requesting application upon receiving confirmation from the master enqueue service that no other enqueue service of one or more other enqueue services managed by the master enqueue service has the object locked.

12. A system as in claim 11, wherein the operations further comprise sending an acknowledgement to the requesting application.

13. A system as in claim 11, wherein the master enqueue service is one of the one or more other enqueue services.

14. A system as in claim 11, wherein the lock is not implemented if the master enqueue service does not provide confirmation that no other enqueue service has the object locked.

15. A system as in claim 11, wherein the lock is not implemented if the master enqueue service replies with a denial, thereby indicating that another enqueue service managed by the master enqueue service has the object locked

16. A system as in claim 11, wherein the one or more other enqueue services comprise a plurality of other enqueue services.

17. A system as in claim 11, wherein the computer hardware comprises a programmable processor and a machine-readable medium storing instructions that, when executed by the programmable processor, cause the programmable processor to perform at least some of the operations.
